(19) United States
(12) Patent Application Publication
(10) Pub. No.: US 2010/0066187 A1
(43) Pub. Date: Mar. 18, 2010

(54) INTRODUCED IN ELECTRIC MOTOR

(76) Inventor: Oscar Rolando Avila CUSICANQUI, Sao Tucsupaya Baja (BO)

Correspondence Address: LADAS & PARRY LLP, 224 SOUTH MICHIGAN AVENUE, SUITE 1600, CHICAGO, IL, 60604, US

(21) Appl. No.: 12/211,168

(22) Filed: Sep. 16, 2008

(51) Int. Cl. H02K 21/28

(52) U.S. Cl. 310/154.02

(57) ABSTRACT

“IMPROVEMENT INTRODUCED IN ELECTRIC MOTOR”, foreseeing an electric motor indicated by reference (M) essentially comprising a stator (1), incorporating at least a coil (2) which is positioned or mounted in parallel with at least a respective fixed magnet (3), and when the current (C) is enabled, the flow (F) created by the coil (2) presents the same magnetic signal that the flow for the fixed magnet (3), closing the circuit though the air gap area (4), in the direction of rotor (5), to other air gap area (4) and to the core, the same occurring with the flow for the fixed magnet (3), passing from the core to the stator, to the air gap (4), to the rotor (5) and to other air gap area (4) and again to the core, then closing the circuit, creating two flows (F) that are combined to promote the rotation for the rotor (5); on the other hand, when the current is disabled, the flow for the fixed magnet enters in toroid setup, such as indicated by reference (F1) going through the core of the stator (1); foreseeing a fixed magnet (3) in the stator (1) in parallel with the coil (2) of said stator, and when the motor is not powered, the flow for the fixed magnet (3) is in closed circuit, inside the stator (1), since when the motor is enabled, with DC current, said current flows through the coil (2) of the casing or rotor (5) and through stator of field coil (1), generating a flow in the stator (1) resulting from the passage of the current through the coil (2); the direction of said flow generated by coil (2) is opposed to the direction of current through coil; the direction of said flow generated by coil (2) is opposed to the direction of magnet flow, which is in said closed circuit; when both flows meet, these repel each other and are conducted to the poles and air gap (4) of the motor to interact with the coil flow (2) of the casing or rotor (5) to produce the torque or pair.

This Privilege of Invention patent deals with an improvement introduced in electric engine, which presents an innovative design allowing the electric engine as said to present a higher performance when compared to conventional models, in the savings as well as efficiency.

As it is general knowledge, the devices that convert electric energy in work, through rotation movement induced in a rotor by electromagnetic field yielded by coils mounted on a stator involving the rotor.

The current state of art comprises several types of electric motors that only vary on construction regarding sizing, and all derive from the same fundamental feature, where the yield in the electromagnetic field generated by coils demands the supply of an electrical power current.

In the conventional motors, the work totally yielded is the result of power provided to the motor, or in other words, the operation or work yielded by the motor demands 100% of electric power to be provided to it.

The DC motor owns its name to the fact that the field winding is connected in series with its casing, in such a way that flows the same current through both windings. When a current occurs in a casing, this causes a pulse of a load that is automatically noticed in the field winding.

On the other side, the bypass motor owns its name to the fact that the field and casing winding connects themselves in parallel to the input circuitry, and in this sense, what occurs in the field reflects on the casing.

When the effect of such phenomenon is analyzed from the standpoint of running a motor, it may be assumed that when a motor load elevates, as it is known, in case of a bypass motor, making it reduce the counter-electromotor power, then the casing takes more current to increase the torque, as a first step to yield more speed and counter-electromotor power. Thus, in the motor, this additional current in the casing also flows to field winding in series. It happens due to the field flow increasing and restoring the counter-electromotor power, such that this avoids the motor to acquire speed, as it would occur in a bypass motor.

Thus, a motor of the type abovementioned runs in constant speed. In a bypass motor, when the torque increases, the speed also increases and vice versa. In a motor in series, the opposite occurs, that is, the torque and the speed are inversely proportional. It means that, when the pair is increased, the speed is low, and when the pair is decreased, the speed is high.

In general, in the Bypass DC and DC in SERIES motors, the current increase in the casing also causes the increase in the casing flow, which produces a larger relationship and accelerates the motor. Thus, the field intensity increase has the opposed effect accurateness. When the field intensity is increased, a higher number of current lines appear in the flow for the trajectory of the rotating casing, the generated action is higher and a counter-electromotor power induced increases. Assuming that there is a constant load in the motor, the current in the casing will be reduced and the motor will slowly run. At this point, a certain speed regulation occurs, since the counter-electromotor power also reduces, such that it is possible to flow some additional current in the casing. This new value of the casing current is always slightly lower than the initial value, therefore, the motor speed is somewhat lower than before the field intensity is increased.

With this same rationale, if the field intensity of a motor is reduced, the value for the induced counter-electromotor power is also reduced, making more current to flow in the casing and accelerating the motor.

Again, assuming that there is a constant load, when the motor speed is increased, the induced counter-electromotor power increases and the casing current reaches a value that is sufficient to move the load. Thus, as the load is now propelled with higher speed, it requires more power and the value for casing current also is higher than before.

This Privilege of Invention patent proposes a DC-type electric motor that renews to the extent that it incorporates a fixed magnet in its stator, whose magnet is disposed in parallel assembly with coil of the own stator.

The abovementioned improvement results that the involved electric motor presents the arrangement possibility for the electromagnetic fields of the fixed magnet, and also the coil, from which occurs the positive effect that the electromagnetic field for the magnet is used positively to aid in the motor rotor motion.

In the motor proposed herein, when it has “no magnets”, it will run as a conventional motor, such as described. Thus, assuming somehow the field magnetic flow increases, then it appears a higher number of flow lines in the rotating casing trajectory, or rotor, then the induced counter-electromotor power increases, the casing current is reduced and the motor runs slower.

When, in the motor proposed hereby, with fixed load and “with magnets”, the stator or “field”, the physical introduction of a magnet in said stator or “field”, according to one aspect, increases the flow thereof without increasing the motor current, showing a higher number of flow lines in the rotating casing trajectory, thereby the induced counter-electromotor power increases and the field and casing current, which is the motor consumption current, is reduced. Now, with the new system, that is, with the stator being presented with a magnet in parallel with the coil, instead of reducing the motor speed due to said resulting decrease, as it would be logical, it occurs that the speed is considerably increased, thus accelerating said fixed load to a higher speed and with less current consumption, as such phenomenon is exactly opposed to the one occurring in DC in SERIES and Bypass DC conventional motors, or combination thereof, wherein in order to the fixed load be propelled to higher speed, it is necessary more electric power deriving from the consumption line.

In the motor shown herein and with magnets in parallel with the coils, in elevating the speed with fixed load, it is obvious that its energy is increased and, further, the current consumption is reduced. The outcome for the magnets' presence in the stator or field is as it was introduced to the same motor an additional electric power to create a higher magnetic flow in the casing, and as such the current would be based on speed increase with said fixed load and natural losses from the motor.

In the present motor, when the motor field is increased due to the flow contribution of the magnets, it shows a higher number of flow lines and the casing trajectory, therefore, the induced counter-electromotor power is increased causing to lower the consumption current to the field and casing, and thus in this case the motor speed should also lower; instead it does not occur due to the additional field produced by the magnet functioning with the remainder flow for the casing, thus producing a balance to the higher level, that is, with less current consumption, the motor considerably increases from speed to speed with the same load, i.e., the motor output power described herein is increased with less current consumption, obtaining a higher yield than the conventional DC motors (DC in SERIES and Bypass DC). The consumption voltage in this case is maintained in the same level on both circumstances, i.e., “with magnet” and “without magnet”. Without regard to the motor efficiency, when the current is decreased and its speed is increased with fixed load, it is unquestionable that the magnet is functioning as an additional power source.

When this motor is disabled, the fixed magnet in parallel with the coil in the stator enter the toroid, it may also enter and come out in toroid according to the poles' switching of a motor. In this case, no magnetic field is flowing to the rotor when the motor is enabled. It is important to point out that the magnet enters in toroid and comes out of this condition to air gap without spending power.

It is also important to distinguish that in the motor proposed herein, the present magnet reduces the current and, in the other hand, the heat losses, since when making an evaluation for said power losses, it is observed that the increase in the output power is lot higher when compared to the losses. Due to such, the magnet not only reduces the losses, but also confers additional power to the motor.

On tests performed with the motor proposed herein, when it is without the magnets in parallel with the coils, a 45% maximum efficiency is obtained, and when the system shown herein is introduced, its efficiency is increased to 66%, allowing to conclude that there is an increase of 46%.

According to what was proposed, relevant details for obtaining a higher efficiency of this motor are the fact that the crown section of the stator, where the coil is placed in parallel with the magnet, must have the steel used in its sheets of the “MOTOR GRADE” type, a smaller area that is the magnet section area, and the magnet used preferably is the type referred to as “Neodymium”, such that the core magnetic intensity where the coil is located has to be approximately equal to the magnetic density for the magnet in the same section area. Another important aspect is that the magnet flow must be in the opposed direction to the coil flow (N-N), so that both repel each other and follow together to the air gap to interact with the flow generated by the casing coil.

This privilege of invention patent may be completely understood in all details thereof by the observation of the drawings listed below, in which:

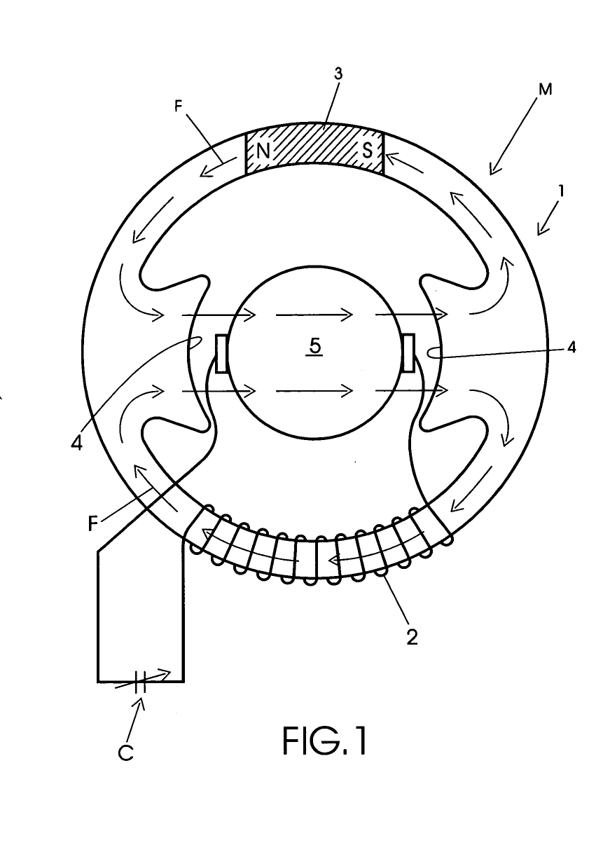

FIG. 1 illustrates a cut and schematic view of the electric motor shown herein in its condition of “enabled motor”; and

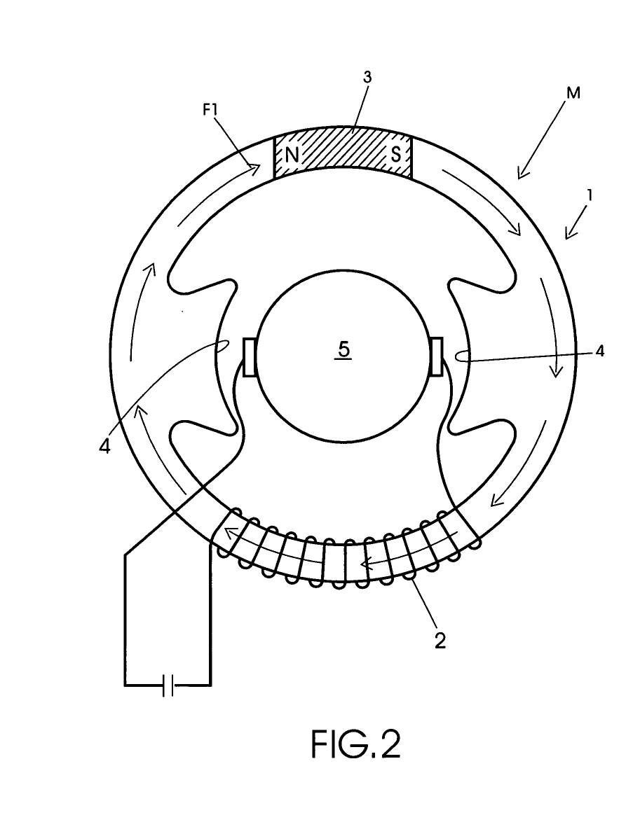

FIG. 2 illustrates a similar view as depicted in FIG. 1, where the motor described herein is shown in its condition of “disabled motor”.

In compliance with the illustrated figures listed above, the electric motor shown herein, which is generically indicated by reference M essentially comprises a stator 1, that incorporates at least a coil 2, which is positioned or mounted in parallel with at least a respective fixed magnet 3.

Such as illustrated in FIG. 1, when the current C is enabled, the flow (indicated by reference F) created by the coil 2 presents the same magnetic signal that the flow for the fixed magnet 3 (North, in this case), closing the circuit through the air gap area 4, in the direction of the rotor 5, to the other air gap area 4 and to the core, the same occurring with the flow for the fixed magnet 3, which passes from the core to the stator, to the air gap 4, to the rotor 5 and to other air gap area 4 and again to the core, then closing the circuit. Such as shown in FIG. 1, two flows F are created, which are combined to promote the rotation for the rotor 5.

On the other hand, when the current is disabled, the flow for fixed magnet enters in toroid setup, such as indicated by reference F1 going to the core of stator 1, such as can be appreciated in FIG. 2.

From the building manner described above, it results that when the electric motor proposed herein is enabled, a condition is created, which combines the flow of the coil 2 with the flow of the fixed magnet 3, whose condition permits the need to a electric power volume 50% smaller than the normal to create a necessary flow for rotating the rotor 5, or in other words, the flow created in the stator 2 to produce the rotation for the rotor 5 demands half the power volume usually required, and the other half of this potential is provided by the flow generated by the fixed magnet 3.

On the other hand, when the flow is stopped, the fixed magnet 3 causes its flow to enter in toroid setup, leaving the air gap area without magnetic field, such as depicted in said FIG. 2.

The improvement shown herein allows the proposed electric motor M to be more efficient, since the flow for the fixed magnet 3 is applied to stator 2 without requiring any spent of electric power.

The improvement in question, by the simplicity thereof, may be applied in DC-type motors as well as AC motors, and also in electric generators in general.

1. “IMPROVEMENT INTRODUCED IN ELECTRIC MOTOR”, wherein it foresees an electric motor indicated by reference (M), which comprises essentially a stator (1), incorporating at least a coil (2) positioned or mounted in parallel with at least a respective fixed magnet (3), and when the current (C) is enabled, the flow (F) created by coil (2) presents the same magnetic signal that the flow for the fixed magnet (3), closing the circuit through the air gap area (4), in the direction of the rotor (5), to other air gap area (4) and to the core, the same occurring to the flow for the fixed magnet (3), passing from the core to the stator, to the air gap (4), to the rotor (5) and to other air gap area (4) and again to the core, then closing the circuit, creating two flows (F) that are combined to promote the rotation for the rotor (5); on the other hand, when the current is disabled, the flow for the fixed magnet enters in toroid setup, such as indicated by reference (F1) going to the stator core (1); being foreseen a fixed magnet (3) in the stator (1) in parallel with the coil (2) in said stator, and when the motor is not powered, the flow for the fixed magnet (3) is in closed circuit, inside the stator (1), since when the motor is enabled, with DC current, said current flows through the coil (2) of the casing or rotor (5) and through stator of field coil (1), generating a flow in the stator (1) resulting from the passage of the current through the coil (2); the direction of said flow generated by coil (2) is opposed to the direction of current through coil; the direction of said flow generated by coil (2) e opposed to the direction of magnet flow which is in said closed circuit; when both flows meet, these repel each other and are conducted to the poles and air gap (4) of the motor to interact with the coil flow (2) of the casing or rotor (5) to produce the torque or pair.

2. “IMPROVEMENT INTRODUCED IN ELECTRIC MOTOR”, which is presented with fixed magnet (3) in the stator (1) in parallel with the coil of said stator, according to claim 1, wherein when increasing the magnetic field of the stator in said motor due to the contribution of magnet flow (3), it appears a higher number of magnetic flow in the casing trajectory or rotor (5), therefore, increasing the induced counter-electromotor power lowering the consumption current, wherein the outcome of this increase of the induced counter-electromotor power is to lower the motor speed, instead, this does not occur due to the additional magnetic flow field produced by the magnet (3) in the stator (1) of the motor, at the same time, interacting with the magnetic flow for the casing, or rotor (5), producing as a result an increase in the motor speed with the same load, therefore, the motor output power is increased and with less current consumption, as a result the magnet is functioning as an additional power source.

3. “IMPROVEMENT INTRODUCED IN ELECTRIC MOTOR”, with fixed magnet (3) in the stator (1), in parallel with the coil (2) of said stator, according to claims 1 and 2, wherein, when increasing the current or decreasing the motor current, the field and casing current that are in series increases or reduces and, therefore, increases or reduces the casing flow, increases or reduces the field flow generated by coil (2) of the stator (1), and this increases or reduces the flow generated by the fixed magnet (3) in said stator (1), as a result upon the current flowing through the field casing in series, controlling the coil flow of the stator and magnet flow, in this sense, controlling the torque and motor speed.

4. “IMPROVEMENT INTRODUCED IN ELECTRIC MOTOR”, with fixed magnet (3) in the stator (1), in parallel with the coil of said stator, according to claims 1, 2 and 3, wherein opposed to what occurs in the DC in SERIES and Bypass DC conventional motors and combinations or Compound thereof, in which, in order for the fixed load to be propelled, the higher speed requires more additional electric power deriving from the consumption line, and in this motor, in order to said fixed load be propelled, the higher speed does not require more additional electric power derived from the consumption line.
